(19) United States
(12) Patent Application Publication
(10) Pub. No.: US 2002/0127415 A1
(43) Pub. Date: Sep. 12, 2002

(54) Process for modifying functionality of organofunctional substrate surfaces

(75) Inventors: Burkhard Standke, Loerrach (DE); Jaroslaw Monkiewicz, Rheinfelden (DE); Albert-Johannes Frings, Rheinfelden (DE); Ralf Laven, Rheinfelden (DE); Roland Edelmann, Wehr (DE); Peter Jenkner, Rheinfelden (DE); Helmut Mack, Rheinfelden (DE); Michael Horn, Rheinfelden (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Dusseldorf (DE)

(21) Appl. No.: 10/035,168

(22) Filed: Jan. 4, 2002

(30) Foreign Application Priority Data
Jan. 5, 2001 (DE) 101 00 384.6

(51) Int. Cl. B32B 9/04

(52) U.S. Cl. 428/447

(57) ABSTRACT

A process for modifying the functionality of organofunctional substrate surfaces by first reacting the organofunctional group of a silicon compound A with the surface of a substrate, where the silicon compound A bears at least one organofunctional group and, as other groups, bears at least one chloro, alkoxy, carboxy or hydroxyl group, then applying to the pretreated substrate an organofunctional silicon compound B, where the silicon compounds A and B are identical or different and the silicon compound B bears at least one chloro, alkoxy, carboxy or hydroxyl group. The process produces surface-modified substrates for other applications.

### BACKGROUND OF THE INVENTION

1. Field of the Invention

The present invention relates to a process for modifying the functionality of organofunctional substrate surfaces. The invention further relates to surface-modified substrates made by the present process, products based on such surface-modified substrates, and to the use of products containing such surface modified substrates.

2. Discussion of the Related Art

It has long been known that the surface properties of a substrate may be altered by coating the substrate with a specific organofunctional silane or siloxane.

In the same way, it is known that organofunctional silanols or silanes and, respectively, siloxanes which bear hydrolyzable groups, such as halo, alkoxy, or carboxy groups, can react by way of at least one of said hydrolyzable groups (including hydroxyl groups) with a substrate surface which is inorganic or which bears OH groups, and thereby bond to the substrate surface.

DE-C 834002 discloses a process for imparting water-repellency to siliceous objects, such as glass, porcelain, quartz, mica, or the like, via treatment with water-repellent substances, in particular hydrolyzable organosilanes or their hydrolysis products or their polymerized hydrolysis products.

There are also known means of rendering substrate surfaces simultaneously repellent to oil, dirt, and water (Swiss Patent 497 599, U.S. Pat. No. 3,012,006). Low-energy surfaces of this type are generally produced by using fluoro-organofunctional compounds.

Besides fluoro-organofunctional systems, there are many other known hydrolyzable or reactive organosilanes and organosiloxanes which can be used to modify the surface properties of inorganic substrates (inter alia EP 0 002 502 A1, DE-A 31 00 555, DE-C 38 36 815, WO 92/21729). For example, hydrolyzable or reactive organosilanes and organosiloxanes may bear, for example, alkyl, alkenyl, methacryloxyalkyl, mercaptoalkyl, glycidyloxyalkyl, aminoalkyl groups as organofunctional group. It is therefore possible to modify the surface properties of substrates in almost any manner desired (see for example German Patent Application 199 08 636.2, and also DE-A 198 49 308, DE-A 198 18 924, DE-A 198 18923 and EP 08 32 911 A1, EP 0 716 128 A2, EP 0 716 127 A2, EP 0 518 057 B1).

However, the bonding of an organosilane-based coating to an organofunctional substrate is frequently not satisfactory.

In order to improve the bonding of an organosilane to a plastic's surface it has been proposed that an SiO₂ layer is first applied to the plastic's surface, followed by treatment with an organosilane which also bears hydrolyzable groups. Processes of this type are known, see for example DE-A 22 26 655, EP 0 719 743 B1 or JP 49031767 (Showa).

It is also known that the surface of a plastic substrate may be treated in an oxygen-containing plasma atmosphere, or may be oxidized with dichromic acid, in order to render the surface hydrophilic, and that the surface of the resultant activated plastic substrate can be reacted with an organochlorosilane or organoalkoxysilane to form a film which repels water and oil (EP 0 497 189 B1, EP 0 508 136 B1).

### SUMMARY OF THE INVENTION

An object of the present invention is to provide a process for modifying the properties of organofunctional substrate surfaces.

Modifying the surface of an organofunctional substrate includes, but is not limited to, affecting the substrate surface's physical and/or chemical properties including its wettability, hydrophobicity, hydrophilicity, oleophobicity, scratch resistance, particulate repellancy, and repellancy to microorganisms.

Surprisingly, it has been found that it is possible to achieve both excellent bonding of a silane-based coating on an organofunctional substrate surface and achieve a change in the substrate surface's physical or chemical properties if an organofunctional group of a silicon compound A is reacted with the surface of the substrate to form a polar treated surface, where the silicon compound A bears at least one organofunctional group which is crosslinkable with the substrate and, as other groups, bears at least one chloro, alkoxy, carboxy or hydroxyl group. Then applying to the polar treated substrate an organofunctional silicon compound B, where the silicon compounds A and B are identical or different and the silicon compound B bears at least one chloro, alkoxy, carboxy or hydroxyl group.

The present invention therefore provides a process for modifying the functionality of organofunctional substrate surfaces which comprises

reacting the organofunctional group of a silicon compound A with the surface of a substrate to form a polar treated surface, where the silicon compound A bears at least one organofunctional group and, as other groups, bears at least one chloro, alkoxy, carboxy or hydroxyl group,

then

applying to the polar treated surface an organofunctional silicon compound B, where the silicon compounds A and B are identical or different, the silicon compound B bears at least one chloro, alkoxy, carboxy or hydroxyl group and compound B may crosslink with the polar treated surface.

The silicon compounds A used in the process of the invention are preferably those whose organofunctional groups bond and, where appropriate, partially crosslink, either chemically, for example by an elimination reaction or addition reaction, or photochemically, for example via UV initiation or free-radical initiation, or physically, for example by depositing from the gas phase, a thin, uniform layer adsorptively bonded to the substrate.

Compounds A and B may be monomers (organosilanes), oligomers, or polymers (organosiloxanes). These silanes or siloxanes may have identical or different organofunctional groups capable of reacting with the substrate and, bear hydrolyzable groups. Hydrolyzable groups are organofunctional groups. A silicon compound A, in the form of a monomer or oligomer, and having an organofunctional group, may therefore bond to the plastic's surface and optionally crosslink with itself (FIGS. 1 and 2).

Depending on the functionality of the silicon compound A, crosslinking is also possible via reaction of the organofunctional groups (FIG. 2). For example, a primary amino group may react with an epoxy function, or a chloropropyl group with a hydroxyl function.

### BRIEF DESCRIPTION OF THE FIGURES

FIG. 1 shows a process that includes applying a silicon compound to a substrate, condensing the silicon groups with one another, and then further condensing or crosslinking the substrate bonded silicon groups. A crosslinking reaction is shown schematically in FIG. 2.

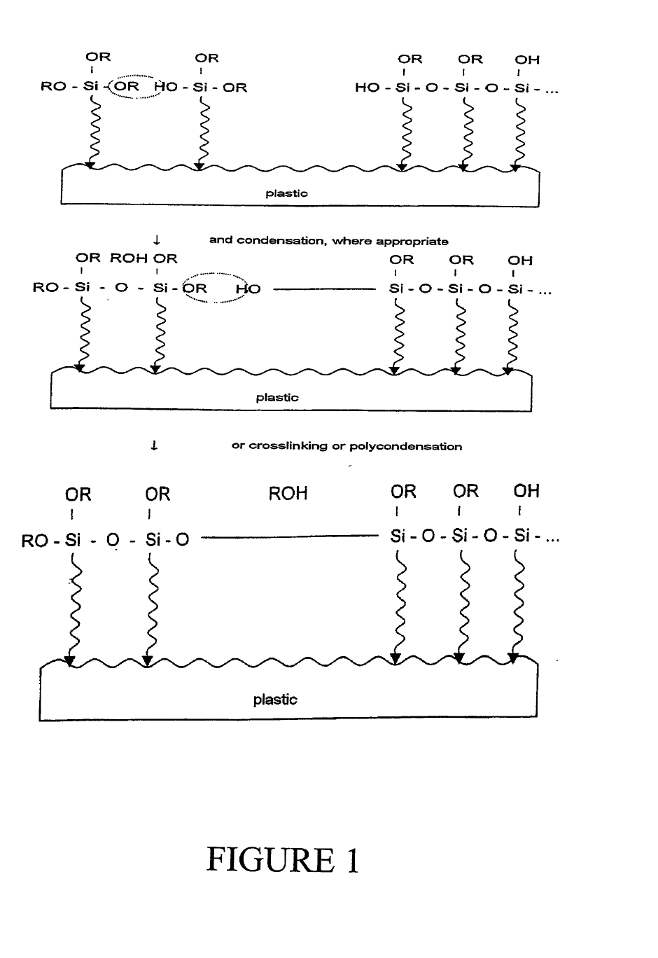

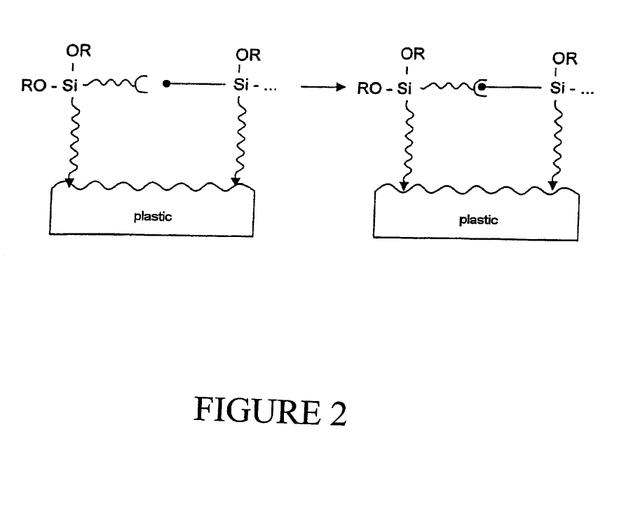

### DETAILED DESCRIPTION OF THE INVENTION

The invention prefereably involves the use of a silicon compound A as described above which, as an organofunctional group, bears a linear, branched or cyclic alkyl group having from 1 to 20 carbon atoms and, where appropriate, having halogen substitution, or bears a ω-alkenyl group having from 2 to 16 carbon atoms, or a methacryloxyalkyl group or an acryloxyalkyl group, or carboxy groups, or aminoalkyl groups, or glycidyloxyalkyl groups, or epoxyalkyl groups, or ureidoalkyl groups, or sulfoxyalkyl groups, or azidoalkyl groups, or mercaptoalkyl groups, or hydroxyalkyl groups, or allyloxyalkyl groups, or alkyleneoxy groups.

It is particularly advantageous in the present process if the reaction of compound A, with the substrate surface is accomplished with pH control and/or in the presence of a solvent and/or in the presence of a free-radical generator, for example a peroxide, such as di-tert-butyl peroxide, dicumyl peroxide, or dibenzoyl peroxide, and/or using an electrostatic and/or thermal, and/or photochemical effect.

The reaction of the silicon compound A with the organofunctional substrate surface forms a polar treated surface where the polar groups of the silicon compound A are oriented away from the substrate surface.

Optional precleaning of the substrate surface is not limited and may take place using acidic or alkaline, aqueous or alcoholic solutions, for example by dipping, drenching, spraying, brushing, polishing, sand blasting, grinding, and sputtering, to mention just a few possibilities.

After reacting silicon compound A with the organofunctional substrate surface the silicon compound B is applied to the treated polar substrate in a manner similar to that used to treat the surface with compound A. The application of the silicon compound B is preferably carried out by spraying, dipping, doctoring, a chemical vapor deposition (CVD) or a physical vapor deposition (PVD), see for example Römpp Chemielexikon (Römpp's Chemical Encyclopedia) under the headings CVD and PVD, incorporated herein by reference.

After each step there may be, where appropriate, neutralization or hydrolysis, heat-treatment for from 1 minute to 5 hours and from 60 to 300° C. and/or a cleaning step. Further thermal post-treatment may also be included.

The heat treatment after reacting silicon compound A with the organofunctional substrate surface the first step of the process of the invention is preferably carried out over a period of from 0.5 to 2 hours at from 80 to 120° C. The heat treatment that follows the application of silicon compound B to the polar treated surface is preferably carried out for a period of from 0.5 to 2 hours at from 100 to 200° C.

The silicone compound A and/or B preferably used in the process of the invention is an organosilane of the general formula I

R¹ₓR²_{y}SiZ_{(4-X-Y)} (I)

where the groups R¹ and R² are identical or different, and each is a linear, branched, or cyclic alkyl group having from 1 to 20 carbon atoms, or a ω-chloroalkyl, ω-bromoalkyl, ω-iodoalkyl, ω-azidoalkyl, ω-cyanoalkyl, ω-cyanatoalkyl, ω-isocyanatoalkyl, fluoroalkyl or perfluoroalkyl, alkenyl, aryl, ω-acryloxyalkyl, ω-methacryloxyalkyl, sulfane, ω-mercaptoalkyl, sulfoxyalkyl, ω-thiocyanatoalkyl, ω-glycidyloxyalkyl, epoxyalkyl, alkenyloxyalkyl, alkoxyalkyl, ω-hydroxyalkyl, aminoalkyl, carbonatoalkyl or a ureidoalkyl group, where each alkylene group appropriately contains from 1 to 6 carbon atoms, R² is preferably methyl, Z is chloro, or a methoxy, ethoxy, isopropoxy, 2-methoxyethoxy or acetoxy group, and x is 1, 2, or 3, and y is 0, 1, or 2, with the proviso that (x+y)≦3.

According to the invention, preference is given particularly, but not exclusively, to the following organosilanes: ethyltrichlorosilane (DYNASYLAN® ATC), methyltrimethoxysilane (DYNASYLAN® MTMS), methyl triethoxysilane (DYNASYLAN® MTES), propyltrimethoxy silane (DYNASYLAN® PTMO), propyltriethoxysilane (DYNASYLAN® PTEO), isobutyltrimethoxysilane (DYNASYLAN® IBTMO), isobutyltriethoxysilane (DYNASYLAN® IBTEO), octyltrimethoxysilane (DYNASYLAN® OCTMO), octyltriethoxysilane (DYNASYLAN® OCTEO), hexadecyltrimethoxysilane (DYNASYLAN® 9116), hexadecyltriethoxy silane (DYNASYLAN® 9216), 3-chloropropyltrialkoxy silanes, 3-bromopropylalkoxysilanes, 3-iodopropyl alkoxysilanes, 3-chloropropyltrichlorosilanes, 3-chloropropylmethyldialkoxysilanes, 3 -chloropropylmethyldichlorosilanes, 3-chloropropyldimethylalkoxy- silanes, 3-chloropropyldimethylchlorosilanes, 3-amino propylmethyldialkoxysilanes, 3-aminopropyltrialkoxy silanes, inter alia, 3-aminopropyltrimethoxysilane (DYNASYLAN® AMMO, 3-aminopropyltriethoxysilane (DYNASYLAN® AMEO), N-(n-butyl)-3-aminopropyltrimethoxy silane (DYNASYLAN® 1189), n-aminoethyl-3-aminopropyl methyldimethoxysilane (DYNASYLAN® 1411), 3-aminopropyl methyldiethoxysilane (DYNASYLAN® 1505), N-aminoethyl-3-aminopropylmethyldialkoxysilanes, N-aminoethyl-3-aminopropyltrimethoxysilane (DYNASYLAN® DAMO), triamino-functional propyltrimethoxysilane (DYNASYLAN® TRIAMO), inter alia, [N-aminoethyl-N′-(3-trialkoxysilylpropyl)]ethylenediamines, and also [N-aminoethyl-N-(3-trialkoxysilylpropyl)]ethylenediamine, triamino functional propylmethyldialkoxysilanes, 3-(4,5-dihydro-imidazolyl)propyltriethoxysilane (DYNASYLAN® IMEO), 3-methacryloxypropylalkoxysilane, 3-methacryloxy-propyltrimethoxysilane (DYNASYLAN® MEMO), 3-methyl acryloxyisobutyltrialkoxysilanes, 3-glycidyloxypropyl trialkoxysilanes, 3-glycidyloxypropyltrimethoxysilane (DYNASYLAN® GLYMO), 3-glycidyloxypropyltriethoxysilane (DYNASYLAN® GLYEO), 3-mercaptopropylalkoxysilanes, 3-mercaptopropyltrimethoxysilane (DYNASYLAN® MTMO), vinyltrichlorosilane (DYNASYLAN® VTC), vinylmethyl dichlorosilane, vinyldimethylchlorosilane, vinyltrialkoxysilanes, inter alia, vinyltrimethoxysilane (DYNASYLAN® VTMO), vinyltriethoxysilane (DYNASYLAN® VTEO), vinyltris(2-methoxyethoxy)silane (DYNA5YLAN® VTMOEO), perfluoroalkyltrialkoxysilanes, fluoroalkyl trialkoxysilanes, inter alia, tridecafluorooctyl trimethoxysilane, tridecafluorooctyltriethoxysilane (DYNASYLAN® F 8261), tridecafluorooctylmethyl dialkoxysilanes, trimethylchlorosilane, triethylchlorosilane, (H₅C₂O)₃Si (CH₂)₃-S₄-(CH₂)₃Si(OC₂H₅)₃ 1,4-bis (3-triethoxysilylpropyl)tetrasulfane (Si-69), (H₅C₂O)₃Si(CH₂)₃-NCS 3-thiacyamidopropyltriethoxysilane (Si-264), (H₅C₂O)₃Si(CH₂)₃-S₂-(CH₂)₃Si(OC₂H₅)₃ 1,2-bis(3-triethoxysilylpropyl)disulfane (Si-266), 3-cyano-propyltrialkoxysilanes inter alia 3-cyanopropyl-trimethoxysilane, N,N′,N″-tris(trimethoxysilylpropyl) triisocyanurate, 3-[methoxy(polyethyleneglycide)] propyltrialkoxysilanes, allyltrialkoxysilanes, allylmethyldialkoxysilane, allyldimethylalkoxysilane, allyltrichlorosilane, allylmethyldichlorosilane, allyldimethylchlorosilane, 3-methacryloxy-2-methylpropyltrialkoxysilanes, 3-amino-2-methylpropyltrialkoxy silanes, (cyclohex-3-enyl)-ethyltrialkoxysilanes, alkyl N-(3-trialkoxysilylpropyl)carbamates, 3-azidopropyltrialkoxysilanes, 4-(2-trialkoxysilylethyl)-1,2-epoxy cyclohexanes, bis(3- alkoxysilylpropyl)amines, tris(3-alkoxysilylpropyl)amines, 3-acryloxypropyltrialkoxysilanes, inter alia 3-acryloxymethyldialkoxy silanes, 3-acryloxydimethylalkoxysilanes, to mention just a few examples, and it is advantageous here for one of the alkoxy groups mentioned to be methoxy, ethoxy, 2-methoxyethoxy, propoxy or acetoxy.

Other preferred silicon compounds A and B useful in the process of the invention are organosiloxanes based on at least one organosilane of the general formula I, or in particular organosiloxanes found in the German Patent Applications 199 55 047.6, 199 61 972.7, EP 0 518 057, EP0 590 270, EP0 716 127, EP0 716 128, EP0 760 372,EP0 814 110,EP0 832 911, EP0 846 717, EP0 846 716, EP 0 846 715, EP0 953 591, EP0 955 344, EP0 960 921, EP 0 978 525, EP 0 930 342, EP 0 997 469, EP 1 031 593 and EP 0 075 697, all incorporated herein by reference.

Mixtures of the abovementioned organosilanes of formula I and mixtures of said organosilanes and the abovementioned organosiloxane are also suitable.

According to the invention, therefore, the silicon compounds A and/or B may be in either a monomeric, oligomeric, or cocondensed form, either pure or as a mixture. Silicon compounds A and/or B suitable for use in the present process may be in dissolved, emulsified, or suspended form. Examples of solvents for silicon compounds A and/or B are water, ethanol, methanol, isopropanol, methyl ethyl ketone, acetone, toluene, xylene, dimethyl ether, dry-cleaning gasoline, tetrahydrofuran, cyclohexane and, where appropriate, mixtures of these, to mention just a few possibilities.

The surface properties of the following organofunctional substrates, in particular, may be modified by coating according to the invention: plastics, in particular polymers such as polyethylene (PE), polypropylene (PP), polyamides (PA), polyesters, polyacrylates, polyurethane (PU), polystyrene, polycarbonates, polyvinyl chloride (PVC), polyethylene terephthalate (PET), silicones, and also melamine resins, carbon fibers, furan resins, alkyd resins, bismaleimide-triazine resins, synthetic elastomers, such as SB rubber or nitrite rubber, and compositions, such as acrylonitrile-butadiene-styrene copolymers (ABS) and ethylene-vinyl acetate copolymer (EVA). For the purposes of the present invention, the organofunctional substrates used may likewise be natural substances, such as wood or rubber. It is therefore possible to treat consumer articles based on the abovementioned plastics and also textiles and textile fibers.

The process of the invention may be generally carried out as follows:

The substrate may be coated with a monomeric or oligomeric organofunctional silane or siloxane which has at least one chloro, alkoxy, carboxy or hydroxyl group, and having an organic substituent polymerizable by chemical, photochemical, or physical processes. The monomeric or oligomeric organofunctional silane or siloxane on the organofunctional substrate may then undergo reaction with both the substrate to form a coating and with itself and/or other organofunctional silanes or siloxanes present to form a polymer, thereby forming a polar treated surface. During this process the silicon compound A and/or resultant polymer bearing silyl groups prepared during application and/or reaction of compound A, becomes oriented on the substrate surface, thus achieving bonding to the substrate surface. The extent of this bonding depends essentially on the compatibility with the substrate, and on topographical and steric conditions. This bonding may result from reaction of the organic substituents and the effect of pH, i.e. by adding an acid or a base or appropriate salts, or acid anhydrides, for example HCl, HNO₃, HCOOH, CH₃COOH, H₃PO₄, H₂SO₄, or amines, or Na₂CO₃, NaOH, NH₄Cl, CH₃COONa, CH₃COONH₄, and/or the effect of electrostatic factors, such as charging of the substrate surface, and/or, depending on the type and concentration of reactive groups on the substrate surface, with production of elemental bonds, electrostatic interactions, acid/base interaction, or hydrogen bridges.

Due to their inherently polar character, the chloro, alkoxy, carboxy, or hydroxyl groups generally orient facing away from the substrate surface, thus allowing a very long-lasting polar coating to be obtained with establishment of a vertical concentration gradient. Where appropriate, the above mentioned processes may be followed by thermal post-treatment or cleaning.

An organofunctional alkoxy-, carboxy- or hydroxysilane is then applied to the polar treated surface, for example by deposition using CVD or PVD, or by spraying, dipping, drenching, brushing, doctoring, polishing or rolling. Where appropriate, the application takes place in the presence of small amounts of water.

The process generally gives essentially full-surface bonding of the secondary layer of the second step to the polar primary coating formed by the reaction of silicon compound A with the organofunctional substrate surface, with three-dimensional crosslinking. Where appropriate, application of silicon compound B may be followed by a cleaning step and/or heat-treatment. A cleaning step may encompass a neutral, acidic, or alkaline washing procedure. There may also be a thermal post-treatment, for example in an indoor atmosphere, an inert gas atmosphere, or in vacuo, in a drying system.

The present invention provides a surface-modified substrate obtainable by the process of the invention.

The present invention also provides products which are based on a surface-modified substrate of the invention, for example plastic sheets, plastic pipes, plastic films, synthetic fibers, synthetic textiles, semifinished products, construction components, injection moldings, furniture and furnishings, window frames, doors, gates, door frames, containers, motor vehicle components, and electrical components, to mention just a few examples.

The process of the invention is also easy to use and has comparatively short treatment times.

The present process generally permits extremely longlasting modification for optimizing a wide range of applications, for example “easy-clean” (dirt-repellant), scratch-resistant coatings, antigraffiti, and run-off effect, by establishing hydrophilic, hydrophobic, or oleophobic surface properties.

The present invention also encompasses the use of the substrates of the invention and of products of the invention as easy-clean surfaces, i.e. surfaces which repel dust and dirt, including surfaces (antigraffiti) which repel paint, or as substrates with a scratch-resistant coating, or else as surfaces provided with repellency to oil and water (run-off effect), and also surfaces such as those which repel microorganisms and bacteria.

The process of the invention offers the advantage of producing coatings capable of firmly adhering to organofunctional substrates with defined functionality. Coatings produced according to the invention therefore usually also have very good mechanical strength, for example when brushed, scrubbed, or walked upon.

German application 10100384.6 filed on Jan. 5, 2001 is hereby incorporated by reference.

The present invention is described in further detail by way of the following non-limiting examples.

### EXAMPLE

Solution 1a: comprises 0.2% by weight of dibenzoyl peroxide, 0.2% by weight of chloro-paraffins, 99.2% by weight of ethanol, 0.4% by weight of 3-methacryloxypropyl trimethoxysilane, and is prepared by mixing 2.0 g of dibenzoyl peroxide (500 strength by weight suspension, phlegmatized in chloroparaffins; PEROXIDCHEMIE) with 2.0 g of 3-methacryloxypropyltrimethoxysilane and 496.0 g of anhydrous ethanol

Solution 1b: comprises 0.5% by weight of dibenzoyl peroxide, 0.5% by weight of chloro paraffins, 97.0% by weight of ethanol, 2.0% by weight of 3-methacryloxy propyltrimethoxysilane, and is prepared by mixing 5.0 g of dibenzoyl peroxide (50% strength by weight suspension, phlegmatized in chloroparaffins; PEROXIDCHEMIE) with 10.0 g of 3-methacryloxypropyltrimethoxysilane and 485.0 g of anhydrous ethanol

Solution 2a: is prepared by stirring 1.0% by weight of tridecafluoro-1,1,2,2-tetrahydro octyltriethoxysilane (DYNASYLAN® F 8261) with 1.0% by weight of distilled water (acidified with CH₃COOH to pH 2.5) and 98% by weight of ethanol for 5 hours. The solution is then ready for use, the processing time being 72 hours.

Solution 2b: is prepared by dissolving 2.2 parts by weight of an oligomeric fluoro/aminofunctional siloxane in 97.2 parts by weight of distilled water and stirring the mixture for a further 2 hours. The solution is then ready for use, the processing time being 72 hours.

### EXAMPLE 1

A paper wipe (untreated) is used to remove the dust from 6 pieces of commercially available acrylic sheeting (ROHM; PMMA VQ 101s; about 15×15 cm), and the static charge is then removed from these pieces. The static contact angles are measured for deionized water and for n-heptane (KRÜSS test apparatus, visual, 5-fold coating).

3 of the pieces are then subjected to a 5-hour boiling test in deionized water. The measurements are repeated after drying at room temperature. In addition, a mechanical abrasion test is undertaken on 3 of the pieces. For this, the pieces are subjected to the stated number of cycles using typical polyester brushes (water film, 2 kg force applied) using forward and backward movement in a single direction in a test machine.

| | Static contact angle | |
|---|---|---|
| | H₂O | n-Heptane |
| Standard | 82° | not measurable* |
| After 5 h boiling water | 79° | not measurable* |
| After 200 scrubbing cycles | 78° | not measurable* |
| After 1000 scrubbing cycles | 75° | not measurable* |

### EXAMPLE 2

Each of 6 pieces of acrylic sheeting is precleaned as in Example 1, treated with solution 2a by dipping for 5 minutes, and then carefully wiped dry using a paper wipe.

After drying for 30 minutes at room temperature, the pieces are thermally post-treated for 1 hour at 80° C. in a laboratory drying cabinet.

The measurements mentioned in Example 1, of contact angle and abrasion, are repeated.

Static contact angle

| | H₂O | n-Heptane |
|---|---|---|
| Standard | 109° | 67° |
| After 5 h boiling water | 108° | 50° |
| After 200 scrubbing cycles | 104° | 46° |
| After 1000 scrubbing cycles | 90° | 38° |

### EXAMPLE 3

Each of 6 pieces of acrylic sheeting is precleaned as in Example 1, treated with solution 2b by dipping for 5 minutes, and then carefully wiped dry using a paper wipe.

After drying for 30 minutes at room temperature, the pieces are thermally post-treated for 1 hour at 80° C. in a laboratory drying cabinet.

The measurements mentioned in Example 1, of contact angle and abrasion, are repeated.

Static contact angle

| | H₂O | n-Heptane |
|---|---|---|
| Standard | 116° | 67° |
| After 5 h boiling water | 110° | 44° |
| After 200 scrubbing cycles | 98° | 38° |
| After 1000 scrubbing cycles | 84° | 28° |

### EXAMPLE 4

Each of 6 pieces of acrylic sheeting is precleaned as in Example 1, treated with solution 1a by dipping for 5 minutes, and then wiped dry using a paper wipe. The substrate surface, which was previously transparent and glossy, has a mat appearance after dipping. The pieces were then subjected to 1 hour of UV irradiation (254 nm) in a closed chamber, whereupon the sheets regained their original optical properties.

Unlike the untreated test specimens, whose surface could not be wetted with distilled water, the treated pieces are completely wettable. This property is retained even after 2 hours of boiling in distilled water. This indicates the presence of a hydrophilic crosslinked polysiloxane film. The methoxysilyl functions hydrolyze with elimination of methanol to give hydroxysilyl groups, or condense further to give polysiloxanes. The reactive methacrylate functions become oriented toward the polyacrylate surface, with chemical bonding (grafting).

The pieces are then dipped in solution 2a for 5 minutes and then placed on edge to drip dry. After drying for 30 minutes at room temperature, the pieces are thermally post-treated for 1 hour at 80° C. in a laboratory drying cabinet.

The measurements mentioned in Example 1, of contact angle and abrasion, are repeated.

Static contact angle

| | H₂O | n-Heptane |
|---|---|---|
| Standard | 110° | 69° |
| After 5 h boiling water | 112° | 59° |
| After 200 scrubbing cycles | 105° | 62° |
| After 1000 scrubbing cycles | 103° | 53° |

### EXAMPLE 5

6 pieces of acrylic sheeting are treated as in Example 4, using solution la and solution 2b.

The measurements mentioned in Example 1, of contact angle and abrasion, are repeated.

Static contact angle

| | H₂O | n-Heptane |
|---|---|---|
| Standard | 115° | 63° |
| After 5 h boiling water | 110° | 56° |
| After 200 scrubbing cycles | 108° | 58° |
| After 1000 scrubbing cycles | 100° | 49° |

### EXAMPLE 6

6 pieces of acrylic sheeting are treated as in Example 4, using solution 1b and solution 2a.

The measurements mentioned in example 1, of contact angle and abrasion, are repeated.

Static contact angle

| | H₂O | n-Heptane |
|---|---|---|
| Standard | 106° | 66° |
| After 5 h boiling water | 102° | 58° |
| After 200 scrubbing cycles | 104° | 60° |
| After 1000 scrubbing cycles | 98° | 52° |

What is claimed is:

1. A process for modifying the surface of an organofunctional substrate comprising
reacting an organofunctional group of a silicon compound A with the surface of an organofunctional substrate to form a polar treated surface, wherein the silicon compound A comprises at least one organofunctional group and at least one chloro, alkoxy, carboxy or hydroxyl group, and further wherein said silicon compound A may react to form a polymer bearing silyl groups,
then
applying to the polar treated surface an organofunctional silicon compound B, wherein the silicon compounds A and B may be identical or different, the silicon compound B bears at least one chloro, alkoxy, carboxy or hydroxyl group, and the silicon compound B reacts with the polar treated surface.

2. The process as claimed in claim 1, wherein the silicon compound A is crosslinked with itself.

3. The process as claimed in claim 2, wherein the silicon compound A is crosslinked by UV irradiation.

4. The process as claimed in claim 1, wherein the organofunctional group of the silicon compound A is a linear, branched or cyclic alkyl group having from 1 to 20 carbon atoms and may optionally be substituted with a halogen or an alkenyl group having from 2 to 16 carbon atoms.

5. The process as claimed in claim 1, wherein the organofunctional group of silicon compound A is reacted with the surface of the organofunctional substrate by the addition of an acid or base, in the presence of a solvent, in the presence of a free radical generator or combinations thereof.

6. The process as claimed in claim 4, wherein the acid or base is selected from the group consisting of HCl, HNO₃, HCOOH, CH₃COOH, H₃PO₄, H₂SO_{4,} an amine, Na₂CO₃, NaOH, NH₄Cl, CH₃COONa, and CH₃COONH₄.

7. The process as claimed in claim 4, wherein said free radical generator is selected from the group consisting of di-tert-butyl peroxide, dicumyl peroxide, or di-benzoyl peroxide.

8. The process as claimed in claim 1, wherein a method used to apply the silicon compound B is selected from the group consisting of spraying, dipping, drenching, brushing, polishing, rolling, doctoring, CVD, and PVD.

9. The process as claimed in claim 1, further comprising heat treating the organofunctional substrate after reacting the organofunctional group of the silicon compound A with the surface of the organofunctional substrate, after applying the organofunctional silicon compound B to the polar treated surface or both.

10. The process as claimed in claim 5, wherein the organofunctional is heat treated from 80 to 120° C. for from 0.5 to 2 hours after reacting the organofunctional group of the silicon compound A with the surface of the organofunctional substrate.

11. The process as claimed in claim 5, wherein the organofunctional substrate is heated from 100 to 200° C. for from 0.5 to 2 hours after applying the organofunctional silicon compound B to the polar treated surface.

12. The process as claimed in claim 1, further comprising pre cleaning the organofunctional substrate by treating said organofunctional substrate with at least one acidic aqueous solution, basic aqueous solution, acid alcoholic solution or basic alcoholic solution.

13. The process as claimed in claim 1, wherein one or both of the silicon compounds A and B is an organosilane of the general formula I
R¹ₓR²_{y}SiZ_{(4-x-y)} (I),
wherein the groups R¹ and R² are identical or different, and each is a linear, branched, or cyclic alkyl group having from 1 to 20 carbon atoms, or a ω)-chloroalkyl, ω-bromoalkyl, ω-iodoalkyl, ω-azidoalkyl, ω-cyanoalkyl, ω-cyanatoalkyl, ω-isocyanatoalkyl, fluoroalkyl, perfluoroalkyl, alkenyl, aryl, ω-acryloxyalkyl, ω-methacryloxy alkyl, sulfane, ω-mercaptoalkyl, sulfoxyalkyl, ω-thiocyanatoalkyl, ω-glycidyloxyalkyl, epoxy alkyl, alkenyloxyalkyl, alkoxyalkyl, hydroxyalkyl, aminoalkyl, carbonatoalkyl or a ureidoalkyl group, where each alkylene group contains from 1 to 6 carbon atoms, Z is a chloro, a methoxy, ethoxy, isopropoxy, 2-methoxyethoxy or acetoxy group, and x is 1, 2, or 3, and y is 0, 1, or 2, and (x+y)≦3, or an organosiloxane based on at least one organosilane of the general formula I, or a mixture of said organofunctional silicon compounds.

14. The process as claimed in claim 1, wherein one or both of silicon compounds A and B is present in monomeric, oligomeric, cocondensed, dissolved, emulsified, or suspended form.

15. The process as claimed in claim 1, wherein the organofunctional substrate comprises a plastic, a composition or a natural substance.

16. The process as claimed in claim 1, wherein the organofunctional substrate is selected from the group consisting of polyethylene, polypropylene, polyamide, polyester, polyacrylate, polyurethane, polystyrene, polycarbonate, polyvinyl chloride, polyethylene terephthalate, silicone, melamine resin, carbon fiber, furan resin, alkyd resin, bismaleimidetriazine resin, ethylene-vinyl acetate copolymer, acrylonitrile-butadiene-styrene copolymer, wood and rubber.

17. A surface-modified substrate produced by the process as claimed in claim 1.

18. A product comprising a surface-modified substrate produced by the process as claimed in claim 1.

19. A process for repelling water, oil, dirt, dust or paint comprising incorporating a substrate obtained by the process as claimed in claim 1 as a coating on an article.
